(19) United States
(12) Patent Application Publication
(10) Pub. No.: US 2002/0147540 A1
(43) Pub. Date: Oct. 10, 2002

(54) Braking system for increased control and braking effectiveness on slippery or icy surfaces

(76) Inventor: Chris T. Vild, Cleveland Heights, OH (US)

Correspondence Address: Chris T. Vild, 2585 Idlewood Road, Cleveland Heights, OH, 44118, US

(21) Appl. No.: 10/040,767

(22) Filed: Feb. 27, 2002

Related U.S. Application Data
(60) Provisional application No. 60/259,852, filed on Jan. 8, 2001.

(51) Int. Cl. B60T 7/12

(52) U.S. Cl. 701/71; 701/82

(57) ABSTRACT

An improved braking system having a sensor which indicates wheel lock up, a sensor which indicates the pressure in the hydraulic brake lines, a container of abrasive material with an outlet line leading to a point just in front of the tire, and an electronically controlled valve in this line. A computer controller opens the valve if the pressure in the hydraulic lines is at or below a predetermined level when the wheel locks up thus ejecting the abrasive material in front of the tire. Abrasive material, such as sand, increases the breaking effectiveness, or coefficient of friction, on ice thus facilitating braking. Importantly, sand can decrease this coefficient of friction if ejected on to a normal, non-icy surface. However, the predetermined pressure level is chosen to correspond to a low coefficient of friction between the vehicle tires and the road and therefore the system will not cause the abrasive material to eject on normal surface, but only on icy or slippery surfaces.

### BACKGROUND: CROSS REFERENCE TO RELATED APPLICATIONS

This application is entitled to the benefit of Provisional Patent Application Serial No. 60/259,852 filed Jan, 8, 2001

### BACKGROUND—FIELD OF THE INVENTION

This invention relates to rolling vehicles such as cars, trucks, busses and even airplanes, specifically, an improved braking system to facilitate control and stopping effectiveness, especially on slippery or icy surfaces.

### BACKGROUND—DESCRIPTION OF PRIOR ART

In order to stop rolling vehicles such as cars, trucks, busses and even airplanes, the most frequently used method employs a static pad (or shoe) fixed to the vehicle which is caused to rub on a rotating disc (or drum) fastened to the wheels thus slowing the vehicle.

Usually the pad (or shoe) is caused to rub on the disk by a hydraulic actuator which in turn is actuated by the vehicle operator using a foot pedal.

On a normal surface (asphalt, cement, etc.) the traditional breaking systems for these vehicles can be effective. However, should such surfaces become ice covered the tires cannot grip the road due to the low coefficient of friction between the tires and the road. In this condition the vehicle can slide along the surface and the brakes become ineffective. Further, the brakes may lock up, that is the wheels no longer rotate and skid on the slippery surface; In this event the vehicle control is lost along with reduced braking capability.

This effect can be minimized somewhat through the use of antilock braking systems (many patents exist in this art), but the low coefficient between the car tires and the slippery or icy surface limits its effectiveness. Antilock brakes are defined as the mechanism using the fact that that the dynamic coefficient of friction (or the friction between two surfaces moving relative to each other as in a skidding car) is less than the static coefficient of friction (or the friction between to surface not moving relative to each other as in a car braking but not skidding). When the vehicle brakes are applied, the pressure to the brakes is increased by the driver until the brakes lock up, and then the brakes are released by a computer until the lockup stops. Then the brakes are again applied by the computer and this is repeated until the car stops or the driver releases the brake. This mechanism takes advantage of the increased coefficient of friction and control in the static friction condition and result in higher breaking effectiveness and control in non-icy and non-slippery surfaces.

The problem with antilock brakes, taking into account the variations in the prior art, is that they do not address the case where both the dynamic and static coefficients of friction are very low as on icy roads. Alternating between the lockup and no lock up simply alternates between two ineffective braking methods.

Further, serious vehicle accidents are often caused by a road condition known as black ice. The condition occurs during periods of warmer weather followed by freezing temperatures (below 32 Fahrenheit), when roads often develop a thin sheet of invisible or “black” ice. This ice is also smoother and more slippery than most ice. Driving on this surface using conventional braking systems is extremely dangerous. The coefficient of friction between the tires and the road becomes very low and steering or stopping safely is impossible. The prior art in braking systems is especially ineffective in black ice conditions and a strong need for an improved braking system exists.

The subject invention addresses the above limitations of the prior art in braking systems leading to a more effective and safer braking system.

### DESCRIPTION OF DRAWINGS

FIG. 1 is a schematic of the invention showing the components of the invention in a typical vehicle.

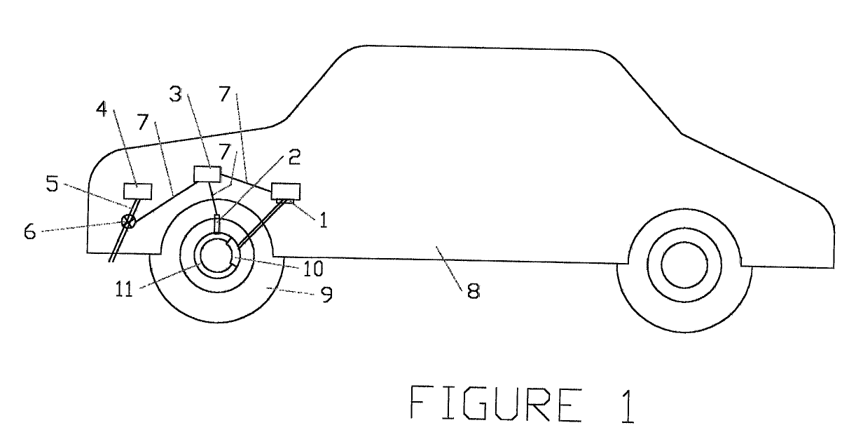

### DESCRIPTION OF THE INVENTION

It is assumed that a conventional hydraulic braking system, with or without anti-locking brake system, is already in place on the vehicle 8 with tires 9. The components of the invention in addition to this system are as follows:

A pressure sensor 1 senses the hydraulic pressure of the hydraulic system, a motion detector 2 which sense the rotation of the wheel, a computer 3 which measures the hydraulic pressure in the braking system, a pressurized container of abrasive or adhesive material 4 with lines 5 leading to valves 6 in the lines 5, just above the road surface, which can be opened electronically in response to a signal from the computer 3. Signal lines 7 carry the signal to and from the components.

### OPERATION OF THE INVENTION

The operation of the invention improves braking performance and increased vehicle control when breaking on slippery surfaces by ejecting an abrasive or adhesive material immediately in front of the vehicle tires thus improving the coefficient of friction. The invention further prevents such ejection when stopping on normal surfaces. This operation of the invention is described as follows:

Whenever the brakes lock up, the computer 3 compares the predetermined threshold pressure to the pressure in the hydraulic system as measured by the pressure sensor 1 at the moment of lock up. The lock up is indicated by zero relative motion between the shoes or pads and the drum or discs. If this pressure is below the predetermined threshold pressure, than this indicates that the vehicle has encountered icy or slippery conditions because it took a relatively easy force (low hydraulic pressure) to lock up the brakes. Should the pressure at lock up be below this threshold, the system actuates (opens) the valve 6 in the abrasive lines and pressure in the abrasive container forces abrasive material to be deposited immediately in front of the wheels. Data indicates that the dispersion of this abrasive material aids greatly in the deceleration of the vehicle. Since the hydraulic pressure necessary to lock up the brakes on normal surfaces is well above the threshold discussed previously, no abrasive material will be deposited in the latter case.

In laboratory tests, various braking conditions were tested to show the coefficients of friction between typical driving conditions and rubber. Each condition was run with and without the abrasive material deposited on the test surface. Results are shown in the list below.

| Surface | Coefficient of friction |
|---|---|
| ice | 0.4 |
| ice sand | 0.7 |
| smooth dry | 0.85 |
| smooth sand | 0.625 |
| smooth wet | 0.9 |
| smooth wet sand | 0.65 |
| rough dry | 1.0 |
| rough dry sand | 0.875 |
| rough wet | 1.05 |
| rough wet sand | 0.7 |

As the results show, the coefficient of friction is increased when the abrasive material is deposited on the ice, which had an extremely low coefficient of friction. The other “normal” surfaces had relatively high coefficients of friction, which were reduced with the depositing of the abrasive material (sand).

In the operation of the invention, the threshold pressure required for opening the valves 6 would be set below the lock up pressure for the “normal” surfaces i.e., non-icy or non-slippery, but slightly above that for the icy surfaces. So when the vehicle experienced lock up on “normal” surfaces, no abrasive material would be deposited, and therefore the braking would not be affected. If however the vehicle experienced lock up on a icy or slippery surface, the threshold pressure would be below that of the set pressure and abrasive material would be deposited and the coefficient of friction between the tires and the driving surface increased, causing an increase in breaking effectiveness.

### ALTERNATIVE EMBODIMENTS

An alternative embodiment is one which the brake system can also act as a traction system. The abrasive material could be ejected manually when traction is lost on slippery of icy surfaces. Further, the system could act automatically. This would be done as in the braking mode, but the system would activate when the torque applied to the wheels necessary to cause slippage was below a predetermined level. This would cause the abrasive material to be ejected only when the coefficient of friction was low, and not when accelerating of normal, non-icy and non-slippery surfaces (where it could decrease traction).

1. A motor vehicle hydraulic brake comprising:
(a) an electric motion sensor to indicate wheel lock up of the vehicle,
(b) a sensor which senses hydraulic pressure in the break lines of said vehicle,
(c) a container of abrasive material with an electronically activated valve with opening on to the vehicle driving surface in front of a tire of said vehicle,
(d) a computer controller with means of opening said electronically activated valve when said pressure sensor measures the pressure for lock up below a predetermined value and opens the valve thus ejecting the abrasive material.

2. The brake of claim 1 wherein said abrasive material is a liquid containing abrasive solids.

3. The brake of claim 1 wherein said fixed value is a function of vehicle speed at lock up.

4. The brake of claim 1 wherein said abrasive material is deposited in front of said vehicle.

5. The brake of claim 1 wherein said material is an adhesive.

6. The brake of claim 1 wherein said material is a salt.

7. The brake of claim 1 wherein said valve can be opened manually by a driver inside the vehicle via an override switch.

8. The break of claim 1 wherein said electronically activated valve opens to different degrees according to vehicle speed thus allowing a specific flow rate of said abrasive material for each speed.

9. A motor vehicle hydraulic brake with anti-lock breaking system comprising:
(e) an electric motion sensor to indicate wheel lock of the vehicle,
(f) a sensor which senses hydraulic pressure in the break lines of said vehicle,
(g) a container of abrasive material with an electronically activated valve opening on to the vehicle driving surface in front of a tire of said vehicle,
(h) a computer controller with means of opening said electronically activated valve when said pressure sensor measures the pressure for lock up below a predetermined value and opens the valve thus ejecting the abrasive material.

10. The brake of claim 9 wherein said abrasive material is a liquid containing abrasive solids.

11. The brake of claim 9 wherein said fixed value is a function of vehicle speed at lock up.

12. The brake of claim 9 wherein said abrasive material is deposited in front of said vehicle.

13. The brake of claim 9 wherein said material is an adhesive.

14. The brake of claim 9 wherein said material is a salt.

15. The brake of claim 9 wherein said valve can be opened manually by a driver inside of vehicle via an override switch.

16. The brake of claim 9 wherein said electronically activated valve opens to different degrees according to vehicle speed thus allowing a specific flow rate of said abrasive material for each speed.

17. A traction system for a motor vehicle comprising:
(a) An sensor with means of indicating tire slippage during acceleration,
(b) An sensor with means of measuring torque applied to said tire during slippage,
(i) A container of abrasive material with an electronically activated valve with opening on to the vehicle driving surface in front or rear of said tire of said vehicle,
(j) A computer with means of opening said electronically activated valve when said torque sensor measures the torque for lock up below a predetermined value and opens the valve thus ejecting the abrasive material.

18. The traction system of claim 17 wherein said abrasive material is a liquid containing abrasive solids.

19. The traction system of claim 17 wherein said abrasive material is deposited on top of the tires.

20. The brake of claim 17 wherein said material is a salt.
